(19) United States
(12) Patent Application Publication
(10) Pub. No.: US 2018/0120649 A1
(43) Pub. Date: May 3, 2018

(54) LIQUID CRYSTAL DEVICE AND ELECTRONIC APPARATUS

(71) Applicant: SEIKO EPSON CORPORATION, Tokyo (JP)

(72) Inventors: Hiroaki YANAI, Azumino-shi (JP); Suguru UCHIYAMA, Suwa-shi (JP)

(73) Assignee: SEIKO EPSON CORPORATION, Tokyo (JP)

(21) Appl. No.: 15/722,730

(22) Filed: Oct. 2, 2017

(30) Foreign Application Priority Data
Oct. 31, 2016 (JP) 2016-212640

(51) Int. Cl. G02F 1/13363; G02F 1/1335; G02F 1/1337; G02F 1/137

(52) U.S. Cl. CPC G02F 1/133632; G02F 1/133502; G02F 1/13439; G02F 1/137; G02F 2201/123; G02F 1/1337

(57) ABSTRACT

A liquid crystal device includes a liquid crystal panel having a liquid crystal layer between an element substrate (first substrate) and a counter substrate (second substrate), and a translucent substrate disposed on a surface of the element substrate which is opposite to the counter substrate. An optical compensation layer which includes a first phase difference compensation element and a second phase difference compensation element formed of an oblique deposition film is integrally laminated on the substrate surface of the translucent substrate which is opposite to the liquid crystal panel. An alignment direction P of the liquid crystal molecules in plan view is a direction between an oblique deposition direction (first direction) of the first phase difference compensation element and an oblique deposition direction (second direction) of the second phase difference compensation element.

### BACKGROUND

### 1. Technical Field

The present invention relates to liquid crystal devices having a phase difference compensation layer, and electronic apparatuses.

### 2. Related Art

In liquid crystal devices that are used as light valves for projection display devices, VA mode liquid crystal devices, for example, are configured such that liquid crystal molecules are substantially vertically aligned when a voltage is not applied to a liquid crystal layer. Accordingly, in the state where a voltage is not applied to the liquid crystal layer (no voltage state), a light beam incident on the VA mode liquid crystal device from the front can be appropriately modulated to thereby achieve high contrast. While a light beam incident from the front is appropriately modulated in the VA mode liquid crystal device, a light beam obliquely incident is affected by a tilt of the liquid crystal molecules, which leads to deterioration of display performance such as a decrease in contrast and gradation inversion by which brightness of the intermediate gradation color is inverted when displayed. Therefore, a structure having a phase difference compensation element provided on the liquid crystal panel has been proposed.

For example, JP-A-2011-180487 proposes a structure having a first phase difference compensation element obliquely deposited in a first direction with respect to the liquid crystal panel in plan view and a second phase difference compensation element obliquely deposited in a second direction such that an alignment direction of the liquid crystal molecules in plan view is between the first direction and the second direction. The first phase difference compensation element and the second phase difference compensation element are formed on different translucent substrates, and the two translucent substrates are stacked with the surfaces on which the first phase difference compensation element and the second phase difference compensation element are respectively formed facing the liquid crystal panel.

The first phase difference compensation element and the second phase difference compensation element which are obliquely deposited have a tendency to adsorb moisture or the like. Accordingly, if the first phase difference compensation element and the second phase difference compensation element are covered by the translucent substrate, a problem arises that front phase difference is likely to vary due to the moisture distributed in the first phase difference compensation element and the second phase difference compensation element. Further, when the surfaces of the translucent substrates on which the first phase difference compensation element and the second phase difference compensation element are formed are bonded via an adhesive, a problem also arises that the front phase difference is likely to vary due to adsorption of a solvent contained in the adhesive.

### SUMMARY

An advantage of some aspects of the present invention is that a liquid crystal device and an electronic apparatus that are less affected by moisture adsorption in the phase difference compensation element despite the use of phase difference compensation element that are obliquely deposited are provided.

In order to solve the above problem, a liquid crystal device according an aspect of the present invention includes: a liquid crystal panel having a liquid crystal layer between a first substrate and a second substrate; a first translucent substrate laminated on a surface of the first substrate which is opposite to the second substrate; and an optical compensation layer integrally laminated on a surface of the first translucent substrate which is opposite to the liquid crystal panel, wherein the optical compensation layer includes a phase difference compensation element made up of an aggregate layer of columnar bodies which are tilted in an oblique direction relative to a substrate surface of the first translucent substrate.

In the above aspect, an optical compensation layer is disposed on a surface of the first translucent substrate which is opposite to the liquid crystal panel, and the optical compensation layer includes a phase difference compensation element made up of an aggregate layer (oblique deposition film) of columnar bodies which are obliquely tilted to the substrate surface of the first translucent substrate. Accordingly, even if the phase difference compensation element adsorbs moisture, the moisture can be smoothly removed since the phase difference compensation element is not covered by the translucent substrate. As a result, despite the use of the phase difference compensation element that is obliquely deposited, effect from moisture adsorption in the phase difference compensation element can be reduced.

In the above aspect, a configuration may be adopted in which liquid crystal molecules used for the liquid crystal layer are oriented to have a pretilt, the optical compensation layer includes, as the phase difference compensation element, a first phase difference compensation element in which a longitudinal direction of the columnar body is oriented in a first direction in plan view as viewed in a direction vertical to the liquid crystal panel, and a second phase difference compensation element in which a longitudinal direction of the columnar body is oriented in a second direction in plan view as viewed in a direction perpendicular to the first direction, and an alignment direction of the liquid crystal molecules in plan view is between the first direction and the second direction. According to this configuration, a phase difference due to the pretilt of the liquid crystal molecule can be compensated. As a result, a decrease in contrast and gradation inversion by which brightness of the intermediate gradation color is inverted are not likely to occur.

In the above aspect, a configuration may be adopted in which the optical compensation layer includes a third phase difference compensation element made up of an aggregate layer of columnar bodies which are vertical to a substrate surface of the first translucent substrate. According to this configuration, a phase difference due to the pretilt of the liquid crystal molecule can be more appropriately compensated. As a result, a decrease in contrast and gradation inversion by which brightness of the intermediate gradation color is inverted are not likely to occur.

In the above aspect, a configuration may be adopted in which a reflection prevention film is laminated on the optical compensation layer which is opposite to the liquid crystal panel. According to this configuration, reflection at the interface between the optical compensation layer and air can be reduced.

In the above aspect, a configuration may be adopted in which a second translucent substrate is laminated on a surface of the second substrate which is opposite to the first substrate, and one of the first substrate and the second substrate is an element substrate having a translucent pixel electrode disposed on a surface facing the other substrate, and the other is an counter substrate having a translucent common electrode disposed on a surface facing the one substrate.

In the above aspect, a configuration may be adopted in which a second translucent substrate laminated on a surface of the second substrate which is opposite to the first substrate, the first substrate is an element substrate having a translucent pixel electrode disposed on a surface facing the second substrate, and the second substrate is an counter substrate having a translucent common electrode disposed on a surface facing the first substrate and a lens formed on a surface opposite to the first substrate with respect to the common electrode to overlap the pixel electrode in plan view.

In the above aspect, a configuration may be adopted in which the first substrate is a counter substrate having a translucent common electrode disposed on a surface facing the second substrate, and the second substrate is an element substrate having a reflective pixel electrode disposed on a surface facing the first substrate.

The liquid crystal device according to an aspect of the present invention can be used for electronic apparatuses such as cell phones, mobile computers, projection display devices and the like. Among these electronic apparatuses, projection display devices include a light source for supplying light to the liquid crystal device, and a projection optical system for projecting light which has been optically modulated by the liquid crystal device.

### BRIEF DESCRIPTION OF THE DRAWINGS

The invention will be described with reference to the accompanying drawings, wherein like numbers reference like elements.

FIG. 1 is a plan view of an aspect of a liquid crystal device according to Embodiment 1 of the present invention.

FIG. 2 is a cross-sectional view of the liquid crystal device shown in FIG. 1 taken along the line II-II.

FIG. 3 is a diagram which illustrates liquid crystal molecules and the like used for the liquid crystal device shown in FIG. 1.

FIG. 4 is a diagram which illustrates a phase difference compensation element used for the liquid crystal device shown in FIG. 1.

FIG. 5 is a diagram which illustrates a planar configuration of a first phase difference compensation element and a second phase difference compensation element shown in FIG. 4.

FIG. 6 is a diagram which illustrates a stereoscopic configuration of a first phase difference compensation element and a second phase difference compensation element shown in FIG. 4.

FIG. 7 is a diagram which illustrates a result of synthesization of anisotropic refractive indices of the first phase difference compensation element, the second phase difference compensation element and the third phase difference compensation element shown in FIG. 4.

FIG. 8 is a cross-sectional view of an aspect of a liquid crystal device according to Embodiment 2 of the present invention.

FIG. 9 is a cross-sectional view of an aspect of a liquid crystal device according to Embodiment 3 of the present invention.

FIG. 10 is a schematic configuration diagram of a projection display device (electronic apparatus) using the liquid crystal device according to the present invention.

### DESCRIPTION OF EXEMPLARY EMBODIMENTS

With reference to the drawings, an embodiment of the present invention will be described. Throughout the drawings, layers and members are not to scale for the convenience of illustration. Further, the term “in plan view” means a view in a direction vertical to a display surface of a liquid crystal panel 100p. In the description of direction or orientation of optical axis and the like herein, a direction in which the flexible wiring substrate 105 is connected to the liquid crystal panel 100p as viewed from an counter substrate 20 is referred to as 6 o'clock direction, a direction opposite to the direction in which the flexible wiring substrate 105 is connected to the liquid crystal panel 100p is referred to 0 o'clock direction, a right direction is referred to as 3 o'clock direction, and a left direction is referred to as 9 o'clock direction.

### Embodiment 1

Configuration of Liquid Crystal Device

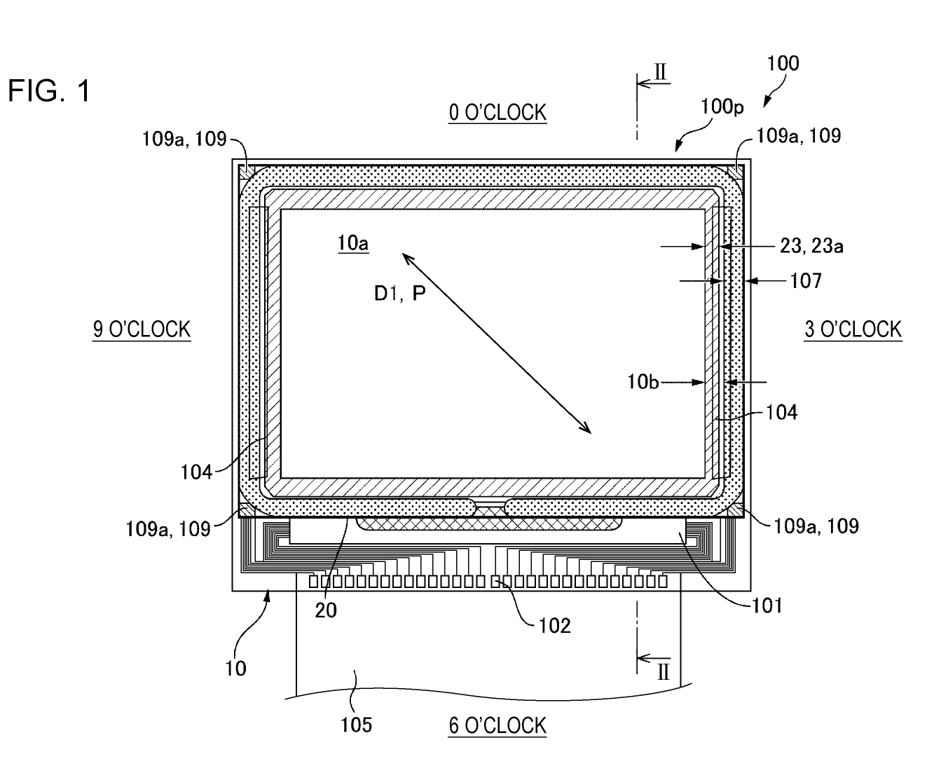

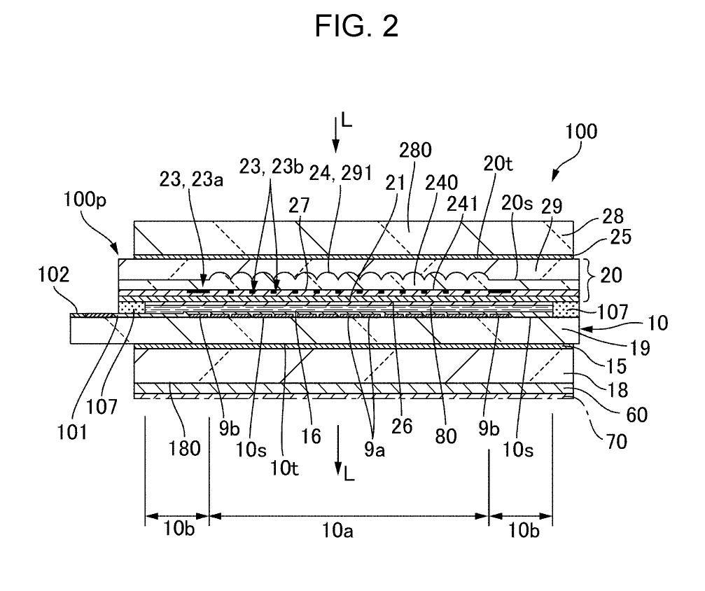

FIG. 1 is a plan view of an aspect of a liquid crystal device 100 according to Embodiment 1 of the present invention, and illustrates the liquid crystal device 100 as viewed from the counter substrate 20. FIG. 2 is a cross-sectional view of the liquid crystal device 100 shown in FIG. 1 taken along the line II-II. In FIG. 1, a translucent substrate 28 (second translucent substrate) shown in FIG. 2 is not illustrated.

In the liquid crystal device 100 of the present embodiment, an element substrate 10 corresponds to a “first substrate” of the present invention, the counter substrate 20 corresponds to a “second substrate” of the present invention. Accordingly, a translucent substrate 18 on the element substrate 10 corresponds to a “first translucent substrate” of the present invention, and a translucent substrate 28 on the counter substrate 20 corresponds to a “second translucent substrate” of the present invention.

As shown in FIGS. 1 and 2, the liquid crystal device 100 includes the liquid crystal panel 100p in which the element substrate 10 (first substrate) and the counter substrate 20 (second substrate) are bonded together by using a seal material 107 via a predetermined gap. In the liquid crystal panel 100p, the element substrate 10 and the counter substrate 20 are opposed to each other. The seal material 107 is disposed in a frame shape along the outer periphery of the counter substrate 20, and a liquid crystal layer is disposed as a liquid crystal layer 80 in a region surrounded by the seal material 107 between the element substrate 10 and the counter substrate 20.

The element substrate 10 and the counter substrate 20 are both shaped in a rectangular shape. A display region 10a is disposed at a substantially center of the liquid crystal device 100 as an oblong region having a longer dimension in 3-9 o'clock direction than in 0-6 o'clock direction. Corresponding to this shape, the seal material 107 is also formed in a substantially oblong shape, and a peripheral region 10b in a rectangular frame shape is provided between the inner periphery of the seal material 107 and outer periphery of the display region 10a.

The base body of the element substrate 10 is a translucent substrate 19 made of quartz, glass, or the like. On a surface (first surface 10s) of the substrate 19 which faces the counter substrate 20, a data line drive circuit 101 and a plurality of terminals 102 are disposed along a first side of the element substrate 10 on the outside of the display region 10a. Further, a scan line drive circuit 104 is disposed along a second side which is adjacent to the first side. A flexible wiring substrate 105 is connected to the terminals 102 so that various electrical potentials and signals are inputted to the element substrate 10 via the flexible wiring substrate 105.

On the first surface 10s of the element substrate 10, a plurality of translucent pixel electrodes 9a made of an indium tin oxide (ITO) film or the like, and pixel switching elements (not shown) electrically connected to the respective pixel electrodes 9a are disposed in a matrix shape in the display region 10a. An alignment film 16 is disposed on the pixel electrodes 9a at a position facing the counter substrate 20 such that the pixel electrode 9a is covered by the alignment film 16. Accordingly, the pixel electrode 9a and the alignment film 16 are laminated in this order on the element substrate 10.

The base body of the counter substrate 20 is a translucent substrate 29 made of quartz, glass, or the like. On the surface (first surface 20s) of the substrate 29 which faces the element substrate 10, a translucent common electrode 21 made of an ITO film or the like is disposed, and an alignment film 26 is disposed on the common electrode 21 at a position facing the element substrate 10. Accordingly, the common electrode 21 and the alignment film 26 are laminated in this order on the counter substrate 20. The common electrode 21 is formed on a substantially entire surface of the counter substrate 20. A light-shielding layer 23 having light-shielding properties made of a metal or metal compound and a translucent protective layer 27 are disposed on the element substrate 10 at a position opposite to the common electrode 21. The light-shielding layer 23 is formed, for example, as a parting member 23a of a frame-like shape which extends along the outer periphery of the display region 10a. Further, the light-shielding layer 23 may also be formed as a black matrix 23b in a region different from the region surrounded by the adjacent pixel electrodes 9a in plan view. In the present embodiment, dummy pixel electrodes 9b which is concurrently formed with the pixel electrode 9a are disposed in the region overlapping the parting member 23a in plan view in the peripheral region 10b of the element substrate 10.

On the element substrate 10, inter-substrate conductive electrodes 109 are disposed in regions outside the seal material 107 and overlapping the corners of the counter substrate 20 so as to establish electrical conduction between the element substrate 10 and the counter substrate 20. An inter-substrate conductive member 109a which contains conductive particles is disposed on the inter-substrate conductive electrode 109 such that the common electrode 21 of the counter substrate 20 is electrically connected to the element substrate 10 via the inter-substrate conductive member 109a and the inter-substrate conductive electrode 109. Accordingly, common electrical potential is applied from the element substrate 10 to the common electrode 21.

In the liquid crystal device 100 of the present embodiment, the pixel electrode 9a and the common electrode 21 are formed by a translucent conductive layer such as an ITO film, and the liquid crystal device 100 is configured as a transmissive liquid crystal device. In this liquid crystal device 100, a light beam which has been incident on one of the element substrate 10 and the counter substrate 20 is modulated while it penetrates and exits the other of the substrates to thereby display an image. In the present embodiment, as indicated by the arrow L, a light beam incident on the counter substrate 20 is modulated by each pixel by the liquid crystal layer 80 while it penetrates and exits the element substrate 10 to thereby display an image.

When the liquid crystal device 100 is used as a light valve or the like of the projection display device, which is described later, the translucent substrate 18 for dust prevention is fixed to a second surface 10t of the element substrate 10 which is a surface opposite to the counter substrate 20 by an adhesive 15 or the like, as shown in FIG. 2. Further, the translucent substrate 28 for dust prevention is fixed to a second surface 20t of the counter substrate 20 which is a surface opposite to the element substrate 10 by an adhesive 25 or the like. Accordingly, dust is not directly attached on the liquid crystal panel 100p, thereby preventing the dust from being reflected into the image. Further, as described later, an optical compensation layer 60 is integrally laminated on the substrate surface of the translucent substrate 18 (first translucent substrate), which is a surface opposite from the liquid crystal panel 100p. As a result, since the optical compensation layer 60 is not covered by the translucent substrate 18 or the like, moisture or the like can be smoothly removed.

### Configuration of Lenses 24 on Counter Substrate 20

A light-shielding layer or a pixel switching element made up of a data line and the like are formed on the first surface 10s of the element substrate 10. The light-shielding layer and the pixel switching element are not light transmissive. Accordingly, in the region in the element substrate 10 which overlaps the pixel electrode 9a in plan view, the region that overlaps the light-shielding layer and the pixel switching element in plan view and the region that overlaps the region sandwiched between the adjacent pixel electrodes 9a in plan view serve as a light-shielding region that does not transmit light. On the other hand, in the region that overlaps the pixel electrode 9a in plan view, the region that does not overlap the light-shielding layer and the pixel switching element in plan view serves as an open region (light transmissive region). As a result, only the light that has transmitted the open region contributes to image display, and the light moving toward the light-shielding region does not contribute image display.

For this reason, the counter substrate 20 is provided with a plurality of lenses 24 each overlapping the corresponding one of a plurality of pixel electrodes 9a in plan view so that the lenses 24 parallelize the light beam incident on the liquid crystal layer 80. As a result, the light beam is incident on the liquid crystal layer 80 with a small tilt of the optical axis, thereby reducing a phase shift in the liquid crystal layer 80 and preventing a decrease in transmittance and contrast. In particular, despite that the tilt of the optical axis of the light beam incident on the liquid crystal layer 80 tends to cause a decrease in contrast or the like since the liquid crystal device 100 of the present embodiment is configured as a VA mode liquid crystal device, the present embodiment can reduce the occurrence of a decrease in contrast or the like.

In forming the lenses 24, a plurality of lens surfaces 291 are formed on the first surface 20s of the substrate 29 such that each overlaps the corresponding one of the plurality of pixel electrodes 9a in plan view. Further, a translucent lens layer 240 is laminated on the first surface 20s of the substrate 29, and the lens layer 240 has a flat surface 241 on the side opposite to the substrate 29. The substrate 29 and the lens layer 240 have different refractive indices, and the lenses 24 are configured by the lens surface 291 and lens layer 240. In the present embodiment, the refractive index of lens layer 240 is larger than the refractive index of the substrate 29. For example, the substrate 29 is made of a quartz substrate (silicon oxide, SiO₂) and has a refractive index of 1.48, while the lens layer 240 is made of a silicon oxinitride (SiON) and has a refractive index in the range of 1.58 to 1.68. As a result, the lenses 24 have a power to converge the light from a light source.

### Configuration of Liquid Crystal Layer 80

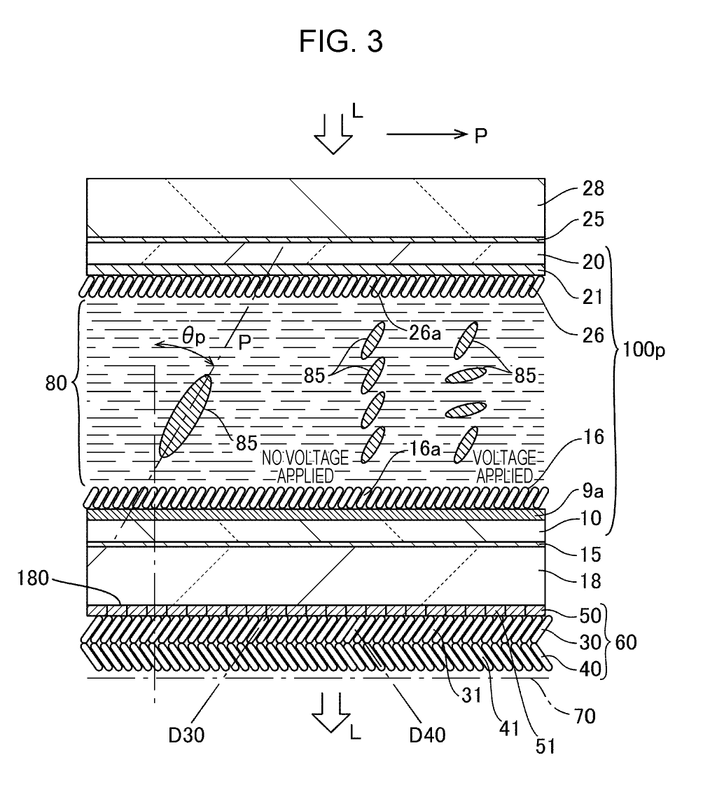

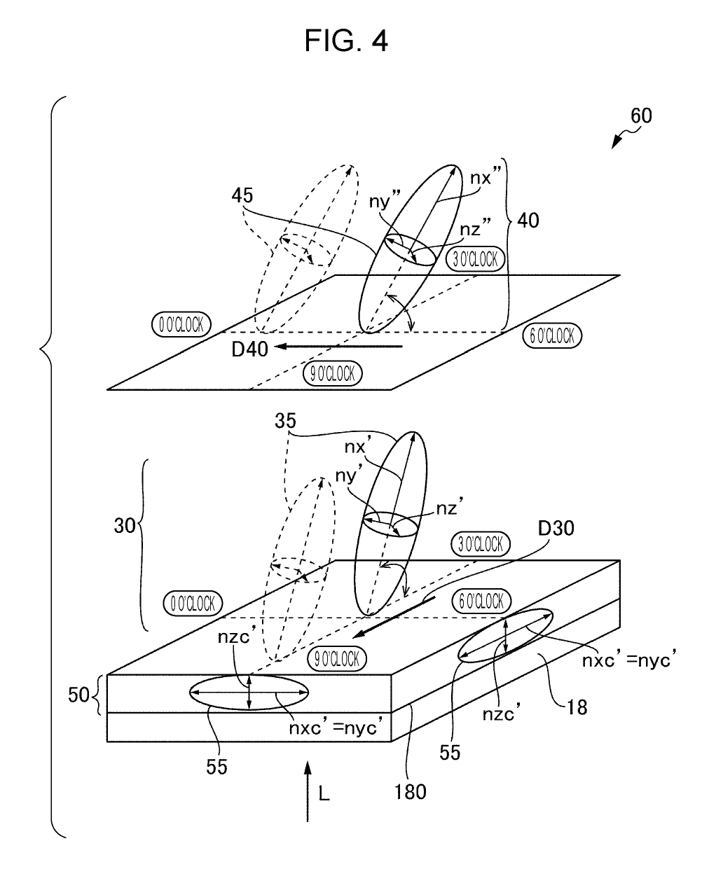

FIG. 3 is a diagram which illustrates liquid crystal molecules 85 and the like used for the liquid crystal device 100 shown in FIG. 1. In FIG. 3, a first phase difference compensation element 30, a second phase difference compensation element 40, and a third phase difference compensation element 50, which are described later, are schematically shown as aggregate layers of columnar bodies 31, 41 and 51. The orientations of the longitudinal axes of the columnar bodies 31, 41 and 51 will be described with reference to FIGS. 4, 5 and 6.

As shown in FIG. 3, the alignment film 16 and the alignment film 26 in the liquid crystal panel 100p are inorganic alignment films (vertical alignment films) formed of an oblique deposition film made of SiOₓ (x≤2), TiO₂, MgO, Al₂O₂, etc. That is, the alignment films 16 and the alignment film 26 are formed of columnar structure layers made up of columnar bodies 16a and 26a, referred to as columns, which are formed oblique relative to the element substrate 10 and the counter substrate 20, respectively. As a result, the alignment film 16 and the alignment film 26 cause the liquid crystal molecules 85 having a negative dielectric anisotropy which are used for the liquid crystal layer 80 to be disposed oblique relative to the element substrate 10 and the counter substrate 20, imparting a pretilt to the liquid crystal molecules 85. Here, an angle formed by the direction vertical to the element substrate 10 and the counter substrate 20 and the longitudinal direction (alignment direction) of the liquid crystal molecules 85 while a voltage is not applied between the pixel electrode 9a and the common electrode 21 is a pretilt angle θp. Thus, the liquid crystal device 100 is configured as a vertical alignment (VA) mode liquid crystal device. In this liquid crystal device 100, when a voltage is applied between the pixel electrode 9a and the common electrode 21, the liquid crystal molecules 85 are displaced in a direction by which a tilt angle relative to the element substrate 10 and the counter substrate 20 is decreased. This displacement direction is a so-called clear vision direction. In this embodiment, as shown in FIG. 1, an alignment direction P (clear vision direction) of the liquid crystal molecules 85 is a direction extending from 4:30 to 10:30 o'clock in plan view.

### Configuration of Optical Compensation Layer 60

As shown in FIGS. 2 and 3, in the liquid crystal device 100 of the present embodiment, the translucent substrate 18 (first translucent substrate) is disposed on the surface of the element substrate 10 (first substrate) which is opposite to the counter substrate 20 (second substrate). Further, an optical compensation layer 60 is integrally laminated on a substrate surface 180 of the translucent substrate 18 which is opposite to the liquid crystal panel 100p. The optical compensation layer 60 includes phase difference compensation elements made up of aggregate layers of the columnar bodies which are tilted in an oblique direction relative to the substrate surface 180 of the translucent substrate 18.

In the present embodiment, the optical compensation layer 60 includes, as the phase difference compensation elements, the first phase difference compensation element 30 in which the longitudinal direction of the columnar body 31 is oriented in the first direction D30 in plan view, and the second phase difference compensation element 40 in which the longitudinal direction of the columnar body 41 is oriented in the second direction D40, which is perpendicular to the first direction D30 in plan view. More specifically, the first phase difference compensation element 30 is a layer formed by oblique deposition performed in the first direction D30, and the second phase difference compensation element 40 is a layer formed by oblique deposition performed in the second direction D40. In the present embodiment, as described later with reference to FIGS. 4, 5 and 6, the alignment direction P of the liquid crystal molecules 85 is a direction located between the first direction D30 and the second direction D40 in plan view. For example, the alignment direction P (clear vision direction) of the liquid crystal molecules 85 is a direction extending from 4:30 to 10:30 o'clock in plan view, while the first direction D30 is a direction extending from 3 to 9 o'clock direction and the second direction D40 is a direction extending from 6 to 0 o'clock direction.

The optical compensation layer 60 further includes the third phase difference compensation element 50 made up of the aggregate layer of the columnar bodies 51, which are vertical to the substrate surface 180 of the translucent substrate 18. Further, in the present embodiment, as indicated by the dot and dash line in FIGS. 2 and 3, a reflection prevention film 70 formed of a dielectric multi-layered film is laminated on the surface of the optical compensation layer 60 which is opposite to the liquid crystal panel 100p.

### Detailed Configuration of Phase Difference Compensation Element

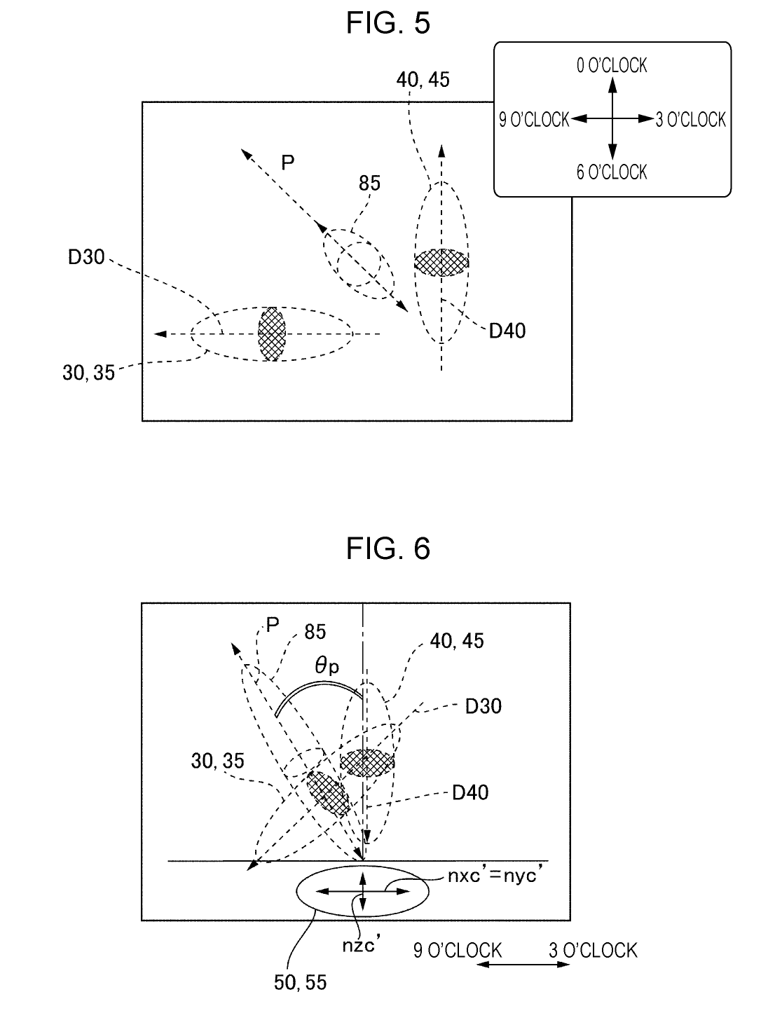

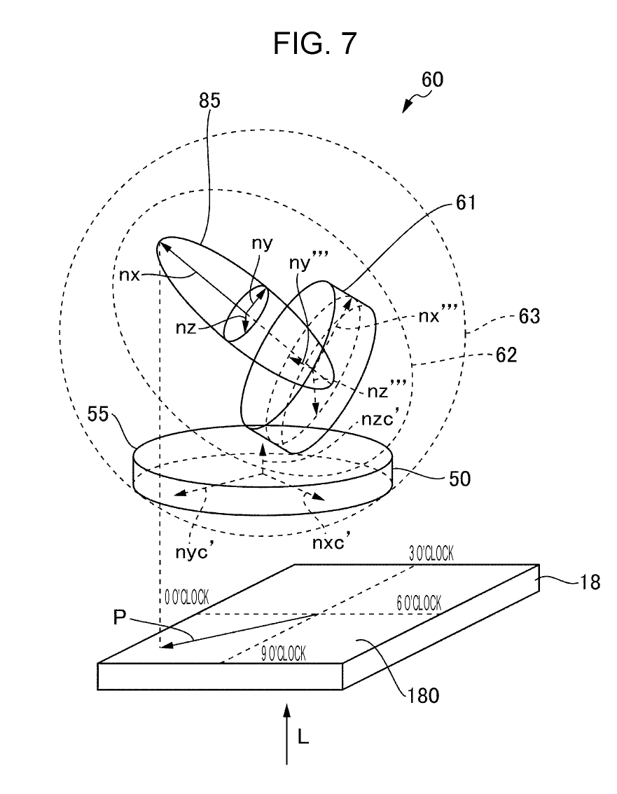

FIG. 4 is a diagram which illustrates a phase difference compensation element used for the liquid crystal device 100 shown in FIG. 1, and the first phase difference compensation element 30, the second phase difference compensation element 40 and the third phase difference compensation element 50 are each illustrated as anisotropic refractive index media 35, 45 and 55. FIG. 5 is a diagram which illustrates a planar configuration of the first phase difference compensation element 30 and the second phase difference compensation element 40 shown in FIG. 4, and schematically illustrates a planar positional relationship between the anisotropic refractive index media 35, 45 of the first phase difference compensation element 30 and the second phase difference compensation element 40, respectively, and the liquid crystal molecules 85. FIG. 6 is a diagram which illustrates a stereoscopic configuration of the first phase difference compensation element 30 and the second phase difference compensation element 40 shown in FIG. 4, and schematically illustrates a stereoscopic positional relationship between the anisotropic refractive index media 35, 45 of the first phase difference compensation element 30 and the second phase difference compensation element 40, respectively, and the liquid crystal molecules 85. FIG. 7 is a diagram which illustrates a result of synthesization of anisotropic refractive indices of the first phase difference compensation element 30, the second phase difference compensation element 40 and the third phase difference compensation element 50 shown in FIG. 4, and conceptionally illustrates the synthesization of the optical anisotropy of the anisotropic refractive index media 35, 45 and 55.

As shown in FIGS. 4, 5 and 6, the first phase difference compensation element 30 is a layer in which the refractive index anisotropic medium 35 having an anisotropic refractive index is obliquely deposited in the first direction D30 which extends from 3 to 9 o'clock, and main refractive indices nx′, ny′ and nz′ of the refractive index ellipsoid of the refractive index anisotropic medium 35 have a relationship of nx′>ny′>nz′. That is, in the refractive index anisotropic medium 35, the refractive index nx′, which is tilted from the direction of normal line to the substrate surface 180 of the translucent substrate 18, is larger than the refractive indices ny′ and nz′ in the other directions. Accordingly, the refractive index ellipsoid of the refractive index anisotropic medium 35 has a rugby ball-like shape which is obliquely tilted to the substrate surface 180 of the translucent substrate 18.

The second phase difference compensation element 40 is a layer in which the refractive index anisotropic medium 45 having an anisotropic refractive index is obliquely deposited in the second direction D40 which extends from 6 to 0 o'clock, and main refractive indices nx″, ny″ and nz″ of the refractive index ellipsoid of the refractive index anisotropic medium 45 have a relationship of nx″>ny″>nz″. That is, in the refractive index anisotropic medium 45, the refractive index nx″, which is tilted from the direction of normal line to the substrate surface 180 of the translucent substrate 18, is larger than the refractive indices ny″ and nz″ in the other directions. Accordingly, the refractive index ellipsoid of the refractive index anisotropic medium 45 has a rugby ball-like shape which is obliquely tilted to the translucent substrate 18.

The third phase difference compensation element 50 is a layer in which the refractive index anisotropic medium 55 is vertically deposited, and the main refractive indices nxc′, nyc′ and nzc′ have a relationship of nxc′=nyc′>nzc′. That is, in the refractive index anisotropic medium 55, the refractive index nzc′ in the thickness direction is smaller than the refractive index in the other directions, and the refractive index ellipsoid of the refractive index anisotropic medium 55 has a disc shape parallel to the translucent substrate 18.

In the optical compensation layer 60 having the above configuration, as shown in FIG. 7, the refractive index anisotropic medium 61 obtained by synthesizing the anisotropic refractive index of the refractive index anisotropic medium 35 which constitutes the first phase difference compensation element 30 and the anisotropic refractive index of the refractive index anisotropic medium 45 which constitutes the second phase difference compensation element 40 has main refractive indices nx″′, ny″′ and nz″′. Of these main refractive indices nx″′, ny″′ and nz″′, the main refractive index nx″′, which is obtained by synthesizing the main refractive index nx′ of the refractive index anisotropic medium 35 which extends in the direction between 3 o'clock and 9 o'clock and the main refractive index nx″ of the refractive index anisotropic medium 45 which extends in the direction between 0 o'clock and 6 o'clock, extends in the direction between 4:30 o'clock and 10:30 o'clock.

On the other hand, in the liquid crystal molecule 85, the refractive index nx′, which is tilted from the direction of normal line to the substrate surface 180, is larger than the refractive indices NY′ and nz′ in the other directions, and extends in the direction between 4:30 o'clock and 10:30 o'clock. Accordingly, a refractive index ellipsoid 62 obtained by synthesizing the anisotropic refractive indices of the liquid crystal molecules 85, the first phase difference compensation element 30, and the second phase difference compensation element 40 can be approximated to the refractive index sphere in three dimension.

Moreover, a refractive index ellipsoid 63 obtained by synthesizing the anisotropic refractive indices of the liquid crystal molecules 85, the first phase difference compensation element 30, the second phase difference compensation element 40 and the second phase difference compensation element 50 can be further approximated to the refractive index sphere in three dimension. Accordingly, phase difference caused by the liquid crystal molecules 85 having a pretilt can be compensated. As a result, a risk of optical leakage is reduced, thereby preventing a decrease in contrast and reduction in viewing angle.

### Main Effect of the Present Embodiment

As described above, in the liquid crystal device 100 of the present embodiment, since the translucent substrates 18 and 28 for dust prevention are fixed to the liquid crystal panel 100p, foreign matters such as dust are prevented from being directly attached to the liquid crystal panel 100p. Accordingly, reflection of foreign matters into the image can be prevented. Moreover, in the present embodiment, since the optical compensation layer 60 is disposed on the surface of the translucent substrate 18 (first translucent substrate) opposite to the liquid crystal panel 100p, there is no need of providing the optical compensation layer 60 on a separate substrate.

Further, the optical compensation layer 60 includes the first phase difference compensation element 30 and the second phase difference compensation element 40 made up of the aggregate layer (oblique deposition layer) of the columnar bodies which are obliquely tilted to the substrate surface 180 of the translucent substrate 18. Accordingly, even if the first phase difference compensation element and the second phase difference compensation element adsorb moisture, the moisture can be smoothly removed since the first phase difference compensation element 30 and the second phase difference compensation element 40 are not covered by the translucent substrate 18. Accordingly, despite the use of the first phase difference compensation element 30 and the second phase difference compensation element 40 which are obliquely deposited, the front phase difference and the like are not likely to be affected by moisture adsorption in the first phase difference compensation element 30 and the second phase difference compensation element 40.

While the liquid crystal molecules 85 is oriented to have a pretilt, the alignment direction P of the liquid crystal molecules 85 in plan view is a direction between the first direction D30 in which the longitudinal axis of the columnar body 31 (refractive index anisotropic medium 35) in the first phase difference compensation element 30 is oriented and the second direction D40 of the columnar body (refractive index anisotropic medium 45) in the second phase difference compensation element 40 is oriented. As a result, since a phase difference due to the pretilt of the liquid crystal molecule 85 can be compensated, a decrease in contrast and gradation inversion by which brightness of the intermediate gradation color is inverted are not likely to occur. Further, the optical compensation layer 60 includes the third phase difference compensation element 50 made up of the aggregate layer of the columnar bodies 51, which are vertical to the substrate surface 180 of the translucent substrate 18. Accordingly, since a phase difference due to the pretilt of the liquid crystal molecule 85 can be more appropriately compensated, a decrease in contrast and gradation inversion by which brightness of the intermediate gradation color is inverted are not likely to occur.

Further, since the reflection prevention film 70 is laminated on the surface of the optical compensation layer 60 opposite to the liquid crystal panel 100p, reflection at the interface between the optical compensation layer 60 and air can be reduced.

Moreover, since the optical compensation layer 60 is disposed on the outgoing side of the display light, it compensates an optical anisotropy of the light after being converged by the lenses 24 (microlenses) and transmitted through the liquid crystal layer 80. Accordingly, contrast of the outgoing light (image) can be successfully maintained.

### Embodiment 2

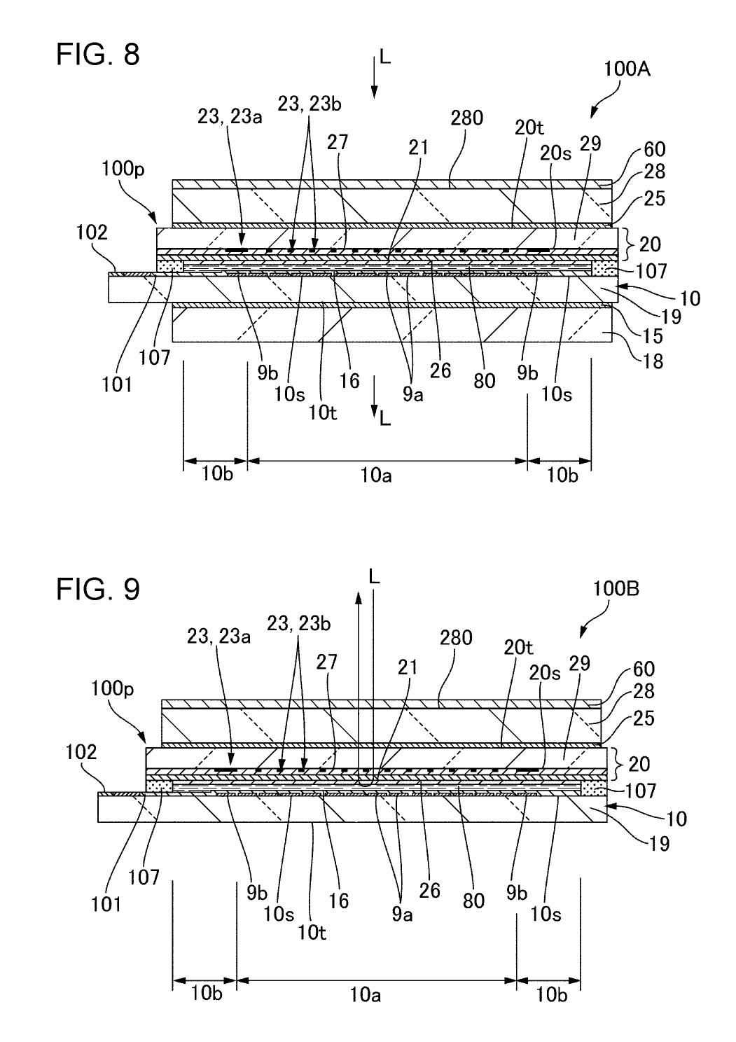

FIG. 8 is a cross-sectional view of an aspect of a liquid crystal device 100A according to embodiment 2 of the present invention. Since the present embodiment and the subsequent embodiment 3 have the same basic configuration as that of embodiment 1, the same reference numerals are used to describe the same elements.

In the liquid crystal device 100A of the present embodiment, the counter substrate 20 corresponds to the “first substrate” of the present invention, and the element substrate 10 corresponds to the “second substrate” of the present invention. Accordingly, the translucent substrate 28 on the counter substrate 20 corresponds to the “first translucent substrate” of the present invention, and the translucent substrate 18 on the element substrate 10 corresponds to a “second translucent substrate” of the present invention.

Although the counter substrate 20 in the embodiment 1 includes the lens 24, the counter substrate 20 in the present embodiment does not include the lens 24 as shown in FIG. 8. Corresponding to this configuration, the optical compensation layer 60 in this embodiment is integrally formed on the substrate surface 280 of the translucent substrate 28 fixed to the counter substrate 20, which is a surface opposite to the liquid crystal panel 100p.

This configuration enables high contrast, which is advantageous over the configuration in which the optical compensation layer 60 is disposed on the translucent substrate 18, since a light beam is incident on the liquid crystal layer 80 after the optical anisotropy of the light is compensated.

### Embodiment 3

FIG. 9 is a cross-sectional view of an aspect of a liquid crystal device 100B according to embodiment 3 of the present invention. In the liquid crystal device 100 of the present embodiment, the counter substrate 20 corresponds to the “first substrate” of the present invention, and the element substrate 10 corresponds to the “second substrate” of the present invention. Accordingly, the translucent substrate 28 on the counter substrate 20 corresponds to the “first translucent substrate” of the present invention.

While the liquid crystal devices 100 and 100A according to embodiments 1 and 2 are transmissive liquid crystal devices, the liquid crystal device 100B of the present embodiment is a reflective liquid crystal device. While the translucent common electrode 21 is formed on the counter substrate 20, reflective pixel electrodes 9a are formed on the element substrate 10. Accordingly, as indicated by the arrow L, a light beam incident on the counter substrate 20 is modulated while it is reflected by the element substrate 10 and exits the counter substrate 20. In the liquid crystal device 100B having the above configuration, as with embodiment 2, the optical compensation layer 60 is integrally formed on the substrate surface 280 of the translucent substrate 28 fixed to the counter substrate 20, which is a surface opposite to the liquid crystal panel 100p.

### Other Embodiments

Although the third phase difference compensation element 50, the second phase difference compensation element 40 and the first phase difference compensation element 30 in the above embodiments are laminated in this order, the order of the lamination may be altered, for example, by laminating the first phase difference compensation element 30, the second phase difference compensation element 40 and the third phase difference compensation element 50 in this order.

### Examples of Application to Electronic Apparatuses

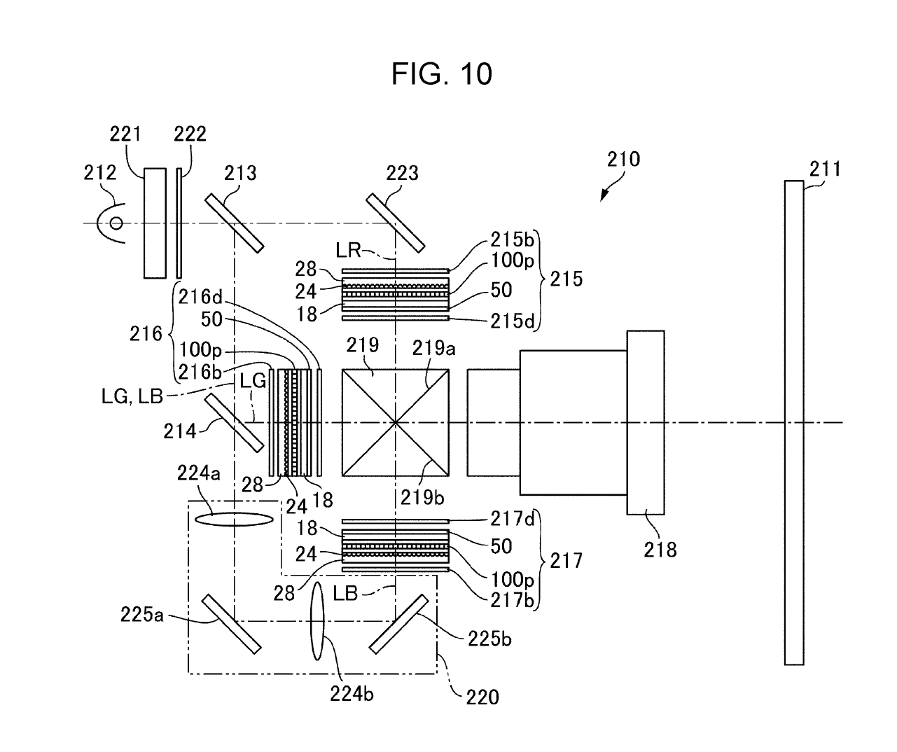

FIG. 10 is a schematic configuration diagram of a projection display device (electronic apparatus) using the liquid crystal device 100, 100A according to the present invention. A plurality of liquid crystal devices (light valves) to which light of different wavelength regions are supplied will be described below. The liquid crystal device 100, 100A according to the present invention are used for all of these liquid crystal devices.

A projection display device 210 shown in FIG. 10 is a front projection type projector that projects an image onto a screen 211 disposed in front of the projection display device 210. The projection display device 210 includes a light source 212, dichroic mirrors 213 and 214, liquid crystal light valves 215 to 217 each constituting the liquid crystal devices according to the present invention, a projection optical system 218, a cross dichroic prism 219, and a relay system 220.

The light source 212 is composed of, for example, an ultra-high pressure mercury lamp that supplies light which contains red light, green light and blue light. The dichroic mirror 213 is configured to transmit a red light LR and reflect a green light LG and a blue light LB emitted from the light source 212. Further, for the green light LG and the blue light LB reflected by the dichroic mirror 213, the dichroic mirror 214 is configured to transmit the blue light LB and reflect the green light LG. Thus, the dichroic mirrors 213 and 214 constitute a color separation optical system that splits the light emitted from the light source 212 into the red light LR, the green light LG, and the blue light LB. Between the dichroic mirror 213 and the light source 212, an integrator 221 and a polarization conversion element 222 are disposed in this order as viewed from the light source 212. The integrator 221 serves to uniform the illuminance distribution of the light emitted from the light source 212. The polarization conversion element 222 converts the light emitted from the light source 212 into a polarized light such as s-polarized light, having a specific oscillation direction.

The liquid crystal light valve 215 is a transmissive liquid crystal device that modulates the red light LR which has been transmitted through the dichroic mirror 213 and reflected by the reflection mirror 223 in response to the image signal. The liquid crystal light valve 215 includes a first polarizing plate 215b, the translucent substrate 28 for dust prevention, the liquid crystal panel 100p, the translucent substrate 18 for dust prevention, and a second polarizing plate 215d. The red light LR which has been incident on the liquid crystal light valve 215 is transmitted through the first polarizing plate 215b and converted, for example, into s-polarized light. The liquid crystal panel 100p converts the incident s-polarized light into p-polarized light (circular polarized light or elliptically polarized light for halftone) by modulation according to the image signal. Further, the second polarizing plate 215d is a polarizing plate that blocks s-polarized light and transmit p-polarized light. Thus, the liquid crystal light valve 215 modulates the red light LR in response to the image signal and outputs the modulated red light LR toward a cross dichroic prism 219. In the present embodiment, the liquid crystal panel 100p includes the lenses 24, and the optical compensation layer 60 is laminated on the substrate surface 180 of the translucent substrate 18 on the outgoing side, which is located opposite to the liquid crystal panel 100p.

The liquid crystal light valve 216 is a transmissive liquid crystal device that modulates the green light LG which has been reflected by the dichroic mirror 213 and then reflected by the dichroic mirror 214 in response to the image signal, and outputs the modulated green light LG to the cross dichroic prism 219. As with the liquid crystal light valve 215, the liquid crystal light valve 216 includes a first polarizing plate 216b, the translucent substrate 28 for dust prevention, the liquid crystal panel 100p, the translucent substrate 18 for dust prevention, and a second polarizing plate 216d, and the optical compensation layer 60 is laminated on the substrate surface 180 of the translucent substrate 18 on the outgoing side, which is located opposite to the liquid crystal panel 100p.

The liquid crystal light valve 217 is a transmissive liquid crystal device that modulates the blue light LB which has been reflected by the dichroic mirror 213, transmitted through the dichroic mirror 214, and has passed through the relay system 220 in response to the image signal, and outputs the modulated blue light LB toward the cross dichroic prism 219. As with the liquid crystal light valves 215 and 216, the liquid crystal light valve 217 includes a first polarizing plate 217b, the translucent substrate 28 for dust prevention, the liquid crystal panel 100p, the translucent substrate 18 for dust prevention, and a second polarizing plate 217d, and the optical compensation layer 60 is laminated on the substrate surface 180 of the translucent substrate 18 on the outgoing side, which is located opposite to the liquid crystal panel 100p.

The relay system 220 includes relay lenses 224a and 224b, and reflection mirrors 225a and 225b. The relay lenses 224a and 224b are provided to prevent light loss of the blue light LB due to the long optical path. The relay lens 224a is disposed between the dichroic mirror 214 and the reflection mirror 225a.

The relay lens 224b is disposed between the reflection mirrors 225a and 225b. The reflection mirror 225a is arranged to reflect the blue light LB, which has been transmitted through the dichroic mirror 214 and has exited the relay lens 224a, toward the relay lens 224b. The reflection mirror 225b is arranged to reflect the blue light LB, which has exited the relay lens 224b, toward the liquid crystal light valve 217.

The cross dichroic prism 219 is a color synthesis optical system including two dichroic films 219a and 219b which are disposed orthogonal to each other in an X-shape. The dichroic film 219a reflects the blue light LB and transmits the green light LG. The dichroic film 219b reflects the red light LR and transmits the green light LG.

Accordingly, the cross dichroic prism 219 is configured to synthesize the red light LR, the green light LG, and the blue light LB modulated by each of the liquid crystal light valves 215 to 217, and to output the synthesized light to the projection optical system 218. The projection optical system 218 includes a projection lens (not shown in the figure), and is configured to project the light synthesized by the cross dichroic prism 219 onto the screen 211.

Moreover, another configuration is also possible in which the liquid crystal light valves (liquid crystal devices) 215 and 217 for the red light and the blue right are provided with a λ/2 phase difference compensation element and convert the light incident on the cross dichroic prism 219 from the liquid crystal light valves 215 and 217 into s-polarized light, while the liquid crystal light valve 216 is not provided with the λ/2 phase difference compensation element and converts the light incident on the cross dichroic prism 219 from the liquid crystal light valve 216 into the p-polarized light.

By allowing different types of polarized light to be incident on the cross dichroic prism 219, an optimized color synthesizing optical system can be provided taking into consideration the reflection characteristics of the dichroic films 219a and 219b. In general, the dichroic films 219a and 219b are excellent in reflection characteristics of the s-polarized light. Accordingly, it is preferred to convert the red light LR and the blue light LB reflected by the dichroic films 219a and 219b into the s-polarized light, and convert the green light LG transmitted through the dichroic films 219a and 219b into the p-polarized light.

### Other Projection Display Devices

The liquid crystal device 100B to which the present invention is applied is used for a reflective projection display device (electronic apparatus). Further, in the projection display device, LED light sources, laser light sources, etc., each emitting different colors of light, may be used as light sources, and the color light emitted from the different light sources may be respectively supplied to different liquid crystal devices.

The liquid crystal device to which the present invention is applied may also be used for projection type headup displays (HUD), direct view-type head mount displays (HMD), and the like, in addition to the above electronic apparatuses.

The entire disclosure of Japanese Patent Application No. 2016-212640, filed Oct. 31, 2016 is expressly incorporated by reference herein.

What is claimed is:

1. A liquid crystal device comprising:
a liquid crystal panel having a liquid crystal layer between a first substrate and a second substrate;
a first translucent substrate disposed on a surface of the first substrate which is opposite to the second substrate; and
an optical compensation layer integrally laminated on a surface of the first translucent substrate which is opposite to the liquid crystal panel, wherein
the optical compensation layer includes a phase difference compensation element made up of an aggregate layer of columnar bodies which are tilted in an oblique direction relative to a substrate surface of the first translucent substrate.

2. The liquid crystal device according to claim 1, wherein
liquid crystal molecules used for the liquid crystal layer are oriented to have a pretilt,
the optical compensation layer includes, as the phase difference compensation element, a first phase difference compensation element in which a longitudinal direction of the columnar body is oriented in a first direction in plan view as viewed in a direction vertical to the liquid crystal panel, and a second phase difference compensation element in which a longitudinal direction of the columnar body is oriented in a second direction in plan view as viewed in a direction perpendicular to the first direction, and
an alignment direction of the liquid crystal molecules in plan view is between the first direction and the second direction.

3. The liquid crystal device according to claim 2, wherein the optical compensation layer includes a third phase difference compensation element made up of an aggregate layer of columnar bodies which are vertical to a substrate surface of the first translucent substrate.

4. The liquid crystal device according to claim 2, wherein a reflection prevention film is laminated on the optical compensation layer which is opposite to the liquid crystal panel.

5. The liquid crystal device according to claim 2, wherein
a second translucent substrate is disposed on a surface of the second substrate which is opposite to the first substrate, and
one of the first substrate and the second substrate is an element substrate having a translucent pixel electrode disposed on a surface facing the other substrate, and the other is an counter substrate having a translucent common electrode disposed on a surface facing the one substrate.

6. The liquid crystal device according to claim 2, wherein
a second translucent substrate disposed on a surface of the second substrate which is opposite to the first substrate,
the first substrate is an element substrate having a translucent pixel electrode disposed on a surface facing the second substrate, and
the second substrate is an counter substrate having a translucent common electrode disposed on a surface facing the first substrate and a lens formed on a surface opposite to the first substrate with respect to the common electrode to overlap the pixel electrode in plan view.

7. The liquid crystal device according to claim 2, wherein
the first substrate is an counter substrate having a translucent common electrode disposed on a surface facing the second substrate, and
the second substrate is an element substrate having a reflective pixel electrode disposed on a surface facing the first substrate.

8. An electronic apparatus comprising the liquid crystal device according to claim 1.

9. An electronic apparatus comprising the liquid crystal device according to claim 2.

10. An electronic apparatus comprising the liquid crystal device according to claim 3.

11. An electronic apparatus comprising the liquid crystal device according to claim 4.

12. An electronic apparatus comprising the liquid crystal device according to claim 5.

13. An electronic apparatus comprising the liquid crystal device according to claim 6.

14. An electronic apparatus comprising the liquid crystal device according to claim 7.
